(19) United States
(12) Patent Application Publication
(10) Pub. No.: US 2007/0022065 A1
(43) Pub. Date: Jan. 25, 2007

(54) Clustering apparatus, clustering method and program

(76) Inventors: Hisaaki Hatano, Yokohama-Shi (JP); Kazuto Kubota, Kawasaki-Shi (JP); Chie Morita, Yokohama-Shi (JP); Akihiko Nakase, Tokyo (JP)

Correspondence Address: NIXON & VANDERHYE, PC, 901 NORTH GLEBE ROAD, 11TH FLOOR, ARLINGTON, VA, 22203, US

(21) Appl. No.: 11/448,983

(22) Filed: Jun. 8, 2006

(30) Foreign Application Priority Data
Jun. 16, 2005 (JP) 2005-176700

(51) Int. Cl. G06F 15/18; G06E 1/00

(52) U.S. Cl. 706/16

(57) ABSTRACT

There is provided with a clustering apparatus including: an initial cluster generator configured to divide multi-dimensional data to generate a plurality of clusters each including one or more data pieces; a cluster recorder configured to record the clusters generated; a cluster selector configured to calculate parameters of a previously given model which is common to the clusters, from each of the clusters, and select clusters to be unified on the basis of the parameters calculated from each cluster; a cluster unifier configured to unify clusters selected by the cluster selector to generate a new cluster; and a cluster evaluator configured to calculate an evaluation value for evaluating a set of the clusters except the unified clusters and the new cluster.

### CROSS-REFERENCE TO RELATED APPLICATIONS

This application is based upon and claims the benefit of priority from the prior Japanese Patent Applications No. 2005-176700 filed on Jun. 16, 2005, the entire contents of which are incorporated herein by reference.

### BACKGROUND OF THE INVENTION

1. Field of the Invention

The present invention relates to a clustering apparatus, a clustering method, and a program.

2. Description of the Background

Needs of data analysis for numerical information such as sensor data at a factories or the like to conduct an output prediction or abnormality detection are increasing. For observed numerical data, there is a mechanism which makes its ground. If the mechanism is sufficiently elucidated, it is possible to construct a strict mathematical model and obtain predicted values from the mathematical model.

In general, however, if a system becomes complicated, it becomes difficult to construct a high precision model which makes strict calculations possible, by numerical equations.

Therefore, it is conducted to construct a model from observed data by using an analysis technique such as data mining. When plural sensor outputs are obtained, the observed data are multi-dimensional data including plural variables. For constructing a model from observed data, it is indispensable to know correlation among variables. In the case where correlation among variables is complicated, it is frequently conducted to divide the data into several sets.

For example, it is supposed that there is a scattering diagram of two variables. It is supposed that this scattering diagram includes broadly two kinds of data groups, i.e., data existing in close vicinity to a certain straight line L1 and data existing in close vicinity to another straight line L2. In this case, it is suitable to divide data into two kinds of data groups and conduct analysis.

If it is not known previously that data is classified into the two straight lines, then it is necessary to conduct processing for automatically dividing data into plural data groups, i.e., clustering processing.

In the conventional clustering technique, however, a desired clustering result, i.e., a clustering result close to intuition of a human being cannot be obtained in some cases. For example, a data group in close vicinity to a certain straight line is often divided in separate clusters.

### SUMMARY OF THE INVENTION

According to an aspect of the present invention, there is provided with a clustering apparatus comprising: an initial cluster generator configured to divide multi-dimensional data to generate a plurality of clusters each including one or more data pieces; a cluster recorder configured to record the clusters generated; a cluster selector configured to calculate parameters of a previously given model which is common to the clusters, from each of the clusters, and select clusters to be unified on the basis of the parameters calculated from each cluster; a cluster unifier configured to unify clusters selected by the cluster selector to generate a new cluster; and a cluster evaluator configured to calculate an evaluation value for evaluating a set of the clusters except the unified clusters and the new cluster.

According to an aspect of the present invention, there is provided with a clustering method comprising: dividing multi-dimensional data to generate a plurality of clusters each including one or more data pieces; recording the clusters generated; calculating parameters of a previously given model which is common to the clusters, from each of the clusters; selecting clusters to be unified on the basis of the parameters calculated from each cluster; unifying clusters selected to generate a new cluster; calculating an evaluation value for evaluating a set of the clusters except the unified clusters and the new cluster; and returning to the selecting in a case where the evaluation value does not satisfy a threshold value.

According to an aspect of the present invention, there is provided with A computer program, comprising instructions for: dividing multi-dimensional data to generate a plurality of clusters each including one or more data pieces; recording the clusters generated; calculating parameters of a previously given model which is common to the clusters, from each of the clusters; selecting clusters to be unified on the basis of the parameters calculated from each cluster; unifying clusters selected to generate a new cluster; calculating an evaluation value for evaluating a set of the clusters except the unified clusters and the new cluster; and returning to the selecting in a case where the evaluation value does not satisfy a threshold value.

### BRIEF DESCRIPTION OF THE DRAWINGS

FIG. 1 is a block diagram schematically showing a clustering apparatus according to an embodiment of the present invention;

FIG. 2 is a flow chart showing a typical processing flow performed by the clustering apparatus shown in FIG. 1;

FIG. 3 is a diagram showing an example of two-dimensional data;

FIG. 4 is a diagram showing an example of initial clusters;

FIG. 5 is a diagram showing straight lines obtained by modeling respective initial clusters in FIG. 4;

FIG. 6 is a diagram showing an example of n-dimensional data;

FIG. 7 is a diagram showing an example of unification of clusters;

FIG. 8 is a flow chart showing an example of concrete processing conducted by a clustering apparatus shown in FIG. 1;

FIG. 9 is a diagram showing an example in which an unsuitable initial cluster has been generated;

FIG. 10 is a diagram showing segment regions;

FIG. 11 is a diagram showing an angle θ formed by two segments and a distance d between gravity-points of the segments; and

FIG. 12 is a diagram showing a region which is within a distance r from a segment.

### DESCRIPTION OF THE EMBODIMENTS

### First Embodiment

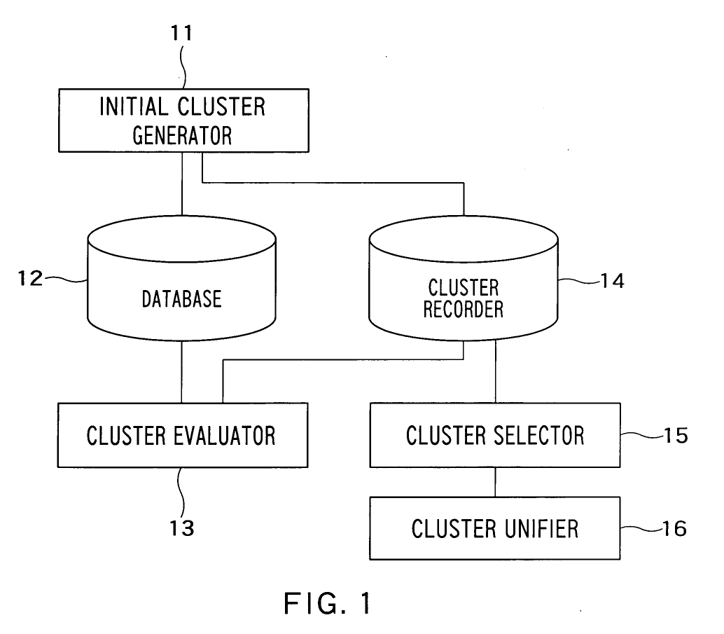

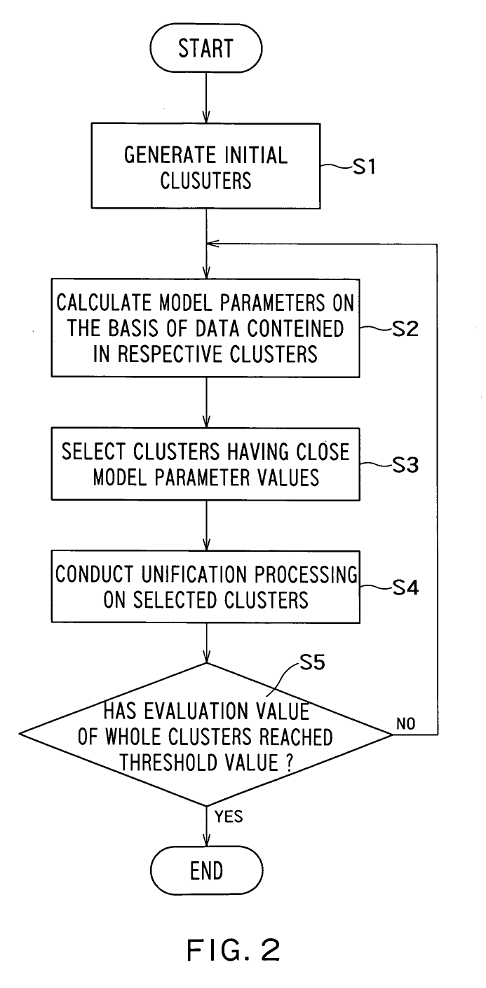

FIG. 1 is a block diagram schematically showing a clustering apparatus according to an embodiment of the present invention. FIG. 2 is a flow chart showing a flow of typical processing conducted by the clustering apparatus shown in FIG. 1.

The clustering apparatus shown in FIG. 1 includes an initial cluster generator 11, a database 12, a cluster evaluator 13, a cluster recorder 14, a cluster selector 15 and a cluster unifier 16. A function conducted by the elements 11 to 16 may be implemented by causing a computer to execute a program generated using an ordinary programming technique, implemented by hardware, or implemented by a combination of them.

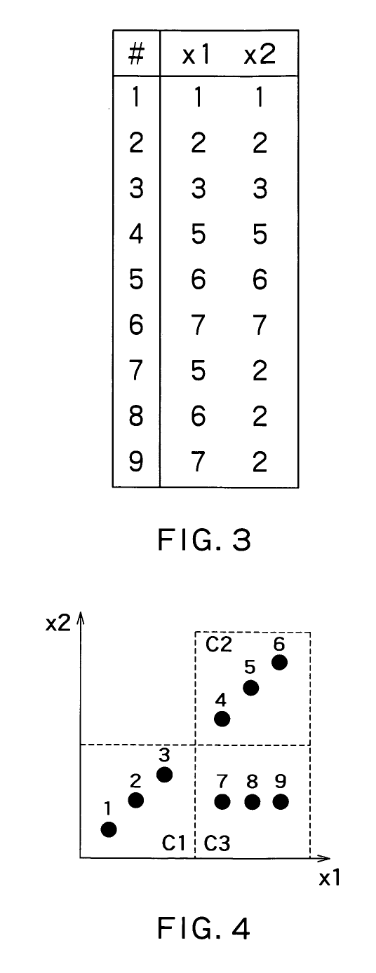

The database 12 stores multi-dimensional data having a sequence length n. An example of two-dimensional data having a sequence length of 9 is shown in FIG. 3. Variables x1 and x2 are data acquired from, for example, first and second sensors in a time series.

The initial cluster generator 11 generates initial clusters from multi-dimensional data stored in the database 12 (S1). The initial clusters are generated by, for example, dividing the multi-dimensional data like mesh

FIG. 4 is a diagram showing an example of generation of initial clusters from the multi-dimensional data shown in FIG. 3.

Nine data included in the multi-dimensional data shown in FIG. 3 are plotted on an x1-x2 plane. The x1-x2 plane is divided like mesh. In other words, the multi-dimensional data are divided using planes (straight lines in the case where the multi-dimensional data is two-dimensional) disposed at definite intervals so as to be perpendicular to the x1 axis and planes disposed at definite intervals so as to be perpendicular to the x2 axis. As a result of the division, clusters C1, C2 and C3 are generated.

The initial cluster generator 11 records the generated clusters C1, C2 and C3 in the cluster recorder 14.

The cluster selector 15 selects clusters to be unified, from a cluster set recorded in the cluster recorder 14. Specifically, the cluster selector 15 calculates parameters of a previously given model which is common to the clusters, from each of the clusters (S2), and selects clusters to be unified, on the basis of the calculated parameters of respective clusters (S3). Hereafter, an example in which clusters C1, C2 and C3 are used as the cluster set and a straight line y=ax+b is used as the previously given model will be described.

Parameters of a straight line model are a gradient “a” and an intercept “b.” A data set belonging to a cluster Ci (i=1, 2, 3) is described as Di. Model Parameters of the straight line calculated from data of Di are denoted as (aᵢ, bᵢ). If |Di|≧2, the parameters of the straight line can be calculated as follows:

$${a}_{i} = \frac{{\sum }_{( {x}_{j} , {y}_{j} ) ∈ {D}_{i}} {x}_{j} {y}_{j} - \frac{1}{n} ( {\sum }_{{x}_{j} ∈ {D}_{i}} {x}_{j} ) ( {\sum }_{{y}_{j} ∈ {D}_{i}} {y}_{j} )}{{\sum }_{{x}_{j} ∈ {D}_{i}} {x}_{j}^{2} - \frac{1}{n} {( {\sum }_{{x}_{j} ∈ {D}_{i}} {x}_{j} )}^{2}} , \\ {b}_{i} = \frac{1}{n} {\sum }_{{y}_{j} ∈ {D}_{i}} {y}_{j} - \frac{{a}_{i}}{n} {\sum }_{{x}_{j} ∈ {D}_{i}} {x}_{j} \qquad ( 1 )$$

An error Ei of a cluster is calculated according to the following equation using the parameters found by the equation (1).

$${E}_{i} = \frac{1}{\vert D \vert} {\sum }_{( {x}_{j} , {y}_{j} ) ∈ {D}_{i}} {( {y}_{j} - {a}_{i} {x}_{j} - {b}_{i} )}^{2} \qquad ( 2 )$$

The error of the cluster means a deviation between the model and the actual data.

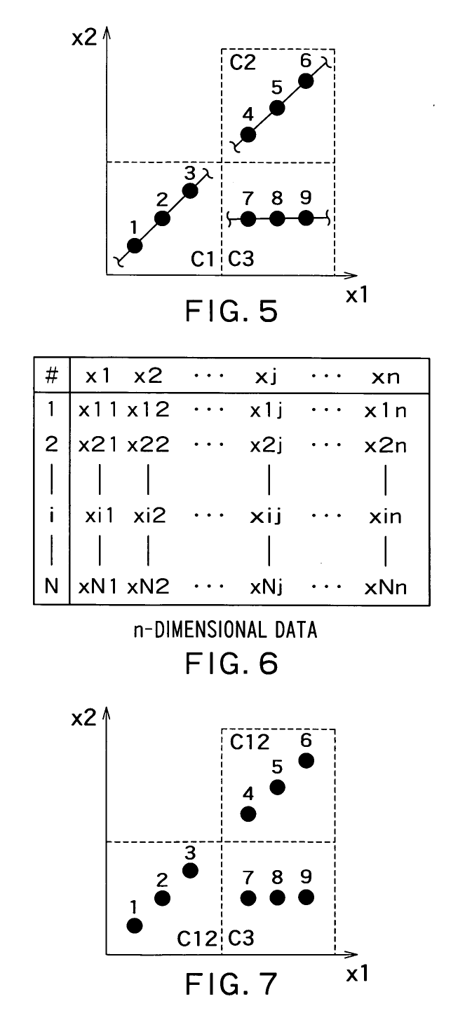

Parameters of the clusters C1, C2 and C3 are found according to the equation (1) as C1:(a₁, b₁)=(1, 0), C2:(a₂, b₂)=(1, 0) and C3:(a₃, b₃)=(0, 2). Straight lines having respective parameters are drawn on the coordinate system in FIG. 4 as shown in FIG. 5. Here, all cluster pairs are generated by combining the clusters C1, C2 and C3. As a result, (C1, C2), (C1, C3) and (C2, C3) are generated. Parameter distances are calculated with respect to (C1, C2), (C1, C3) and (C2, C3), and the calculated distances are compared among them. As a result, it is appreciated that the distance between parameters of (C1, C2) is the shortest (the same) as described hereafter. Therefore, the clusters C1 and C2 become unification candidates. Here, clusters having a shortest distance between parameters have been selected as unification candidates. Alternatively, all pairs of two clusters having a distance which is equal to or less than a predetermined value may be selected as unification candidates. The distance between parameters is calculated, for example, as below.

Handling “aᵢ” representing a gradient of a straight line and “bᵢ” representing a y-intercept with the same weight, a distance D between two clusters C1:(a₁, b₁) and C2:(a₂, b₂) is calculated as follows:

$$D = \sqrt{{( {a}_{1} - {a}_{2} )}^{2} + {( {b}_{1} - {b}_{2} )}^{2}} \qquad ( 3 )$$

Or laying weight on the gradients of the two clusters, the distance D may be calculated as follows:

$$D = \sqrt{{A ( {a}_{1} - {a}_{2} )}^{2} + {( {b}_{1} - {b}_{2} )}^{2}} \qquad ( 4 )$$

Here, A is a positive constant greater than unity.

The case where the multi-dimensional data are two-dimensional has been described heretofore. Alternatively, multi-dimensional data having a higher dimension may also be used.

In general, when data are plotted on an n-dimensional space, a hyperplane can be represented by using (n+1) coefficients aᵢ (i=0, 1, . . . n) (here, n coefficients among them are independent) as follows:

$${a}_{0} + {\sum }_{i = 1}^{n} {a}_{i} {x}_{i} = 0 , \\ ( {\sum }_{i = 1}^{n} {a}_{i}^{2} = 1 ) \qquad ( 5 )$$

If there are N pieces of data in n-dimensional data as shown in FIG. 6, the coefficients can be found as follows:

$$[ \begin{matrix}{a}_{1} \\ {a}_{2} \\ ⋮ \\ {a}_{n}\end{matrix} ] = {[ \begin{matrix}{C}_{11} & {C}_{12} & ⋯ & {C}_{1 n} \\ {C}_{21} & {C}_{22} & ⋯ & {C}_{2 n} \\ ⋮ & ⋮ & ⋰ & ⋮ \\ {C}_{n 1} & {C}_{n 2} & ⋯ & {C}_{nn}\end{matrix} ]}^{- 1} \cdot ( - {a}_{0} ) [ \begin{matrix}{C}_{1} \\ {C}_{2} \\ ⋮ \\ {C}_{n}\end{matrix} ] , \\ ( \begin{matrix}{C}_{i} = {\sum }_{k = 1}^{N} {x}_{ik} , \\ {C}_{ij} = {\sum }_{k = 1}^{N} {x}_{ik} {x}_{jk}\end{matrix} ) \qquad ( 6 )$$

From the condition in the brackets in the equation (5), a₀ can be determined. Eventually, all of aᵢ (i=0, 1, . . . n) can be determined.

A cluster error can be calculated as follows:

$$\frac{1}{N} {\sum }_{i = 1}^{N} {\vert {a}_{0} + {\sum }_{j = 1}^{n} {a}_{j} {x}_{ij} \vert}^{2} \qquad ( 7 )$$

In the n-dimensional space, a distance between clusters can be defined using (n+1) coefficients aᵢ (i=0, 1, . . . n). For example, the distance between the two clusters C1: sᵢ (i=0, 1, . . . n) and C2: tᵢ (i=0, 1, . . . n) can be defined as follows:

$$D = \sqrt{{\sum }_{k = 0}^{n} {( {s}_{i} - {t}_{i} )}^{2}} \qquad ( 8 )$$

Referring back to FIG. 1, the cluster unifier 16 unifies clusters selected by the cluster selector 15 (S4). In the present example, the clusters C1 and C2 are selected as unification candidates by the cluster selector 15 as described above. The cluster unifier 16 unifies the clusters C1 and C2. A situation in which the clusters C1 and C2 are unified to generate cluster C12 is shown in FIG. 7.

The cluster evaluator 13 calculates an evaluation value for evaluating a cluster set (a set of the clusters C12 and C3) in the cluster recorder 14, and determines whether the evaluation value has reached a threshold value (S5).

For example, a decision is made according to whether the number of clusters in the cluster set has reached a predetermined number K.

If the cluster evaluator 13 judges the evaluation value not to have reached the threshold value (NO at S5), then the processing returns to the step S2 or S3. If the evaluation value has reached the threshold value (YES at S5), then the processing is finished.

In stead of judging whether the number of clusters has reached a predetermined number K, the following method may be taken. That is to say, the processing is finished when a reference value (such as 2k+(E1+E2+ . . . +Ek)/K) calculated using the number k of clusters and errors Ei of respective clusters (where the error and the model parameters of the unified cluster are calculated separately) has changed from a fall to a rise at a timing of the cluster unification.

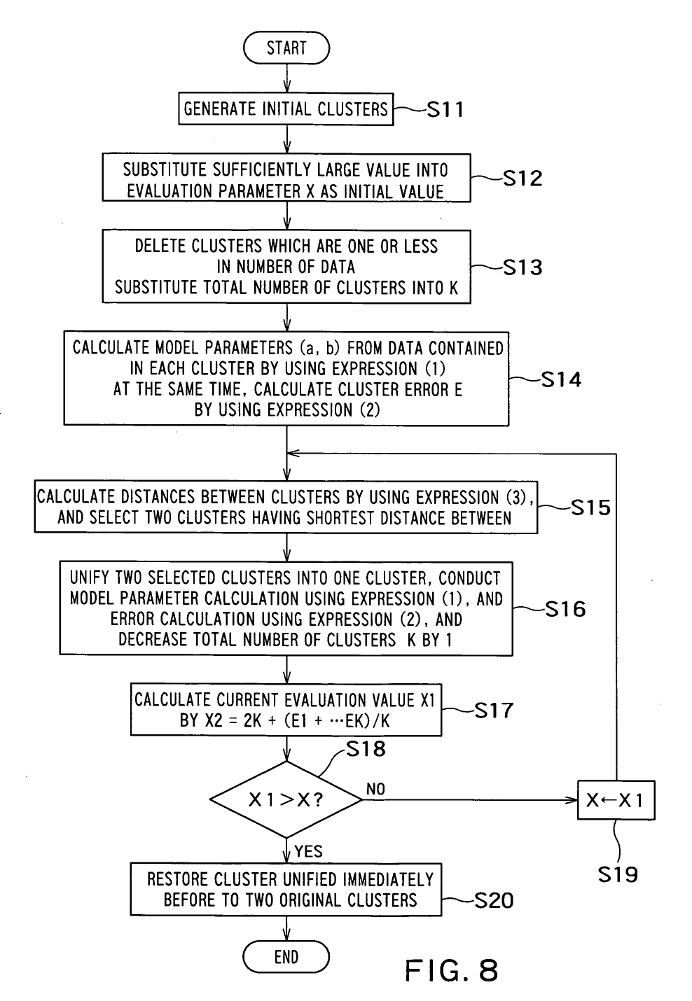

FIG. 8 is a flow chart showing an example of concrete processing conducted by the clustering apparatus shown in FIG. 1.

First, the initial cluster generator 11 generates initial clusters by using the database 12, and records the generated initial clusters into the cluster recorder 14 (S11). Furthermore, the initial cluster generator 11 substitutes a sufficient great value into an evaluation parameter X as its initial value (S12).

The cluster selector 15 deletes clusters which are one or less in the number of data, from the cluster set in the cluster recorder 14, and substitutes the total number of clusters after deletion into K (S13).

The cluster selector 15 calculates model parameters from each of clusters by using data belonging to each cluster according to the equation (1). At the same time, the cluster selector 15 calculates the cluster error of each of the clusters according to the equation (2) (S14).

The cluster selector 15 calculates a distance between two clusters for all pairs of two clusters according to the equation (3), and selects, for example, a pair of two clusters having a shortest distance (S15).

The cluster unifier 16 unifies the selected two clusters into one cluster (S16). The cluster unifier 16 or the cluster selector 15 calculates a model parameter according to the equation (1) and an error according to the equation (2) on the unified cluster, and subtracts 1 from the total number K of clusters (S16).

The cluster evaluator 13 calculates an evaluation value X1 by using, for example, the relation X1=2K+(E1+ . . . Ek)/K (S17), and compares the evaluation value X1 with the evaluation parameter X (S18). If the evaluation value X1 is equal to or less than the evaluation parameter X (NO at S18), then the cluster evaluator 13 substitutes X1 into X (S19), and returns to the step S15. On the other hand, if the evaluation value X1 is greater than the evaluation parameter X (YES at S18), then the cluster unified immediately before is restored to the two original clusters (S20) and the processing is finished.

Effects obtained by the present embodiment will be described as compared with the conventional case.

Clustering is conducted on the initial clusters shown in FIG. 4 by using the conventional method. In general, clustering techniques are broadly divided into two kinds: a division method and an aggregation method. In the division method, regions (clusters) are gradually divided in a top-down manner. In the aggregation method, regions (clusters) fractionated at the start are gradually unified. Here, the case where the aggregation method is used will now be described.

In the case where clusters are unified on the basis of distances between cluster-centers according to a conventional method, calculation of gravity points of the clusters C1, C2 and C3 provides C1:(2, 2), C2:(6, 6) and C3:(6, 2) on the basis of two-dimensional data shown in FIG. 3. Denoting a distance between Ci and Cj by dᵢⱼ, it follows that d₁₂=4×2^{1/2}, d₁₃=4 and d₂₃=4. As a result, clusters to be unified become a combination of C1 and C3 or a combination of C2 and C3. Therefore, data which should originally belong to one straight line do not belong to the same cluster.

On the other hand, if y=ax+b is adopted in the present embodiment as the model as described above, then the combination of the clusters C1 and C2 is selected as a unification candidate and the clusters C1 and C2 are unified. Therefore, in the present embodiment, clustering (data division) close to the intuition of human being becomes possible.

### Second Embodiment

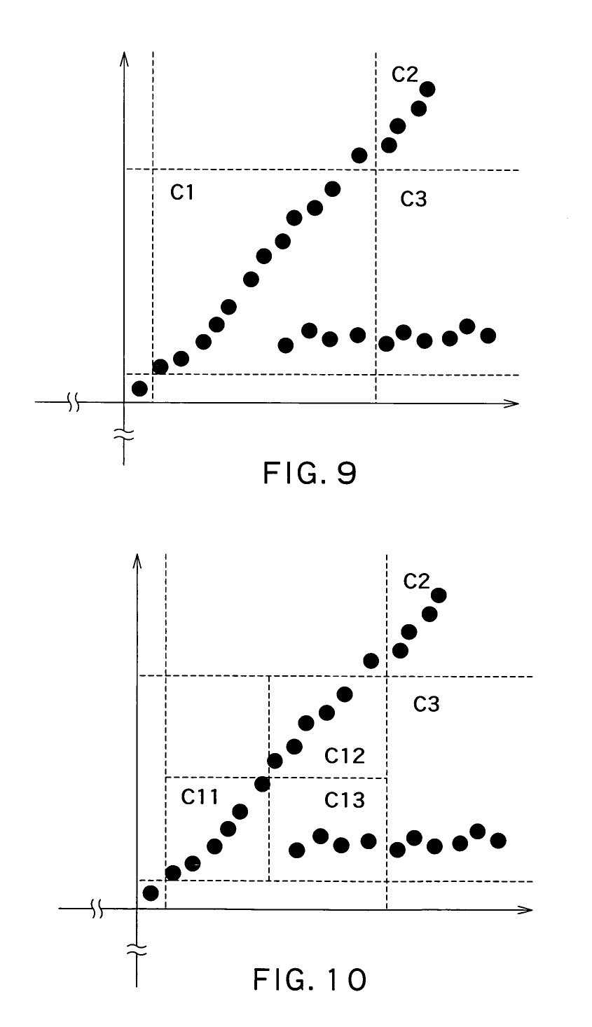

The case where the initial clusters C1, C2 and C3 are made as shown in FIG. 9 is supposed. In such a case, improvement of the classification precision cannot be anticipated even if the cluster unification is continued. It is a feature of the present embodiment to re-divide an unsuitable initial cluster.

In more detail, a straight line (y=ax+b) is found from data contained in an initial cluster by using a least square method. And a deviation of actual data from the straight line, i.e., an error is calculated. As for initial cluster having an error which reaches at least a specified value, the initial cluster is divided into pieces (i.e. plural clusters). For example, the initial cluster is divided using planes (or straight lines) disposed at predetermined intervals so as to be perpendicular to the abscissa axis and planes (or straight lines) disposed at predetermined intervals so as to be perpendicular to the ordinate axis. This processing is conducted by, for example, the initial cluster generator 11.

In the case of FIG. 9, an error in the initial cluster C1 reaches at least the specified value, and consequently the initial cluster C1 is divided into more clusters. A result obtained by dividing the initial cluster C1 is shown in FIG. 10. Thereafter, clustering is continued in the same way as the first embodiment.

### Third Embodiment

In the present embodiment, the case where a segment is used as a model will be described.

Here, as for the method for getting a segment on the basis of data belonging to a cluster (for example, an initial cluster), either a method of selecting two data from the cluster and using the selected two data as both end points of a segment or a method of finding a straight line on the basis of the data belonging to the cluster by using the least square method and cutting out a straight line portion contained in the cluster, may be used. Or, a method of finding a vector parallel to a segment on the basis of an axis which becomes a first main component by using a main component analysis, calculating a straight line so as to pass through a gravity point of data from the vector, and then cutting out a straight line portion contained in the cluster may be used.

The model parameters of the segment are directly represented as coordinates of both end points of the segment. In determining whether to unify two clusters, three parameters, i.e., a segment length ratio I between two segments, an angle θ formed by the segments, and a distance d between gravity points of the segments (gravity point distance) are used as evaluation indexes.

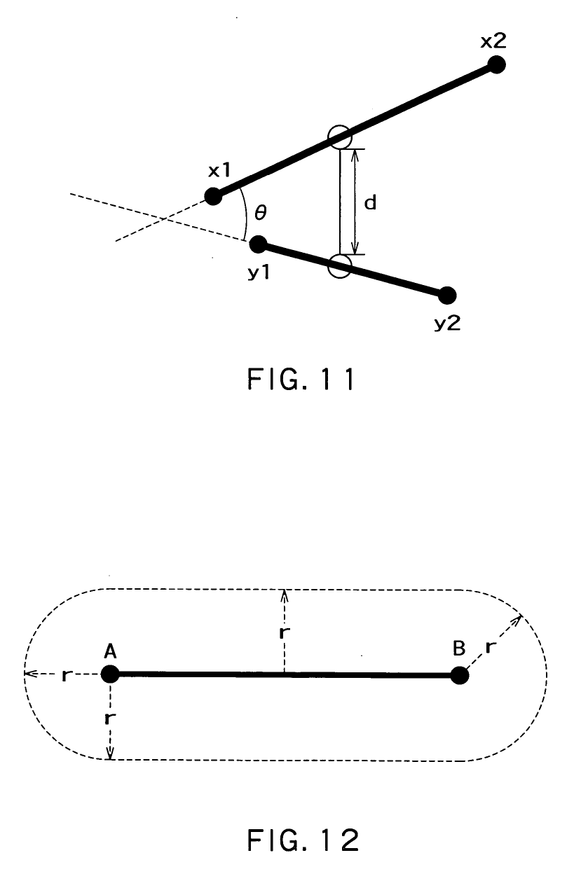

FIG. 11 is a diagram showing the angle θ formed by the segments and the gravity point distance d.

It is supposed that the two segments are a segment x1x2 and a segment y1y2. The end points of the segment x1x2 have coordinates x₁=(x₁₁, x₁₂, . . . x₁ₙ) and x₂=(x₂₁, x₂₂, . . . x₂ₙ), The end points of the segment y1y2 have coordinates y₁=(y₁₁, y₁₂, . . . y₁ₙ) and y₂=(y₂₁, y₂₂, . . . y₂ₙ). A center coordinate of the segment may be selected as the gravity of the segment, or a gravity point of data belonging to a segment region (described later) of the segment may be selected as the gravity point of the segment. If the center coordinate of the segment are used as the gravity point of the segment, the gravity point distance d is given by

$$d = {\sqrt{{\sum }_{k = 1}^{n} ( \frac{{x}_{1 k} + {x}_{2 k}}{2} - \frac{{y}_{1 k} + {y}_{2 k}}{2} )}}^{2} \qquad ( 9 )$$

A cosine of an angle formed by the two segments is given by

$$cos θ = \frac{{\sum }_{k = 1}^{n} ( {x}_{1 k} - {x}_{2 k} ) ( {y}_{1 k} - {y}_{2 k} )}{\sqrt{{\sum }_{k = 1}^{n} {( {x}_{1 k} - {x}_{1 k} )}^{2}} \sqrt{{\sum }_{k = 1}^{n} {( {y}_{1 k} - {y}_{2 k} )}^{2}}} \qquad ( 10 )$$

The segment length ratio I is given by

$$l = \frac{length of segment y 1 y 2}{length of segment x 1 x 2} = \sqrt{\frac{{\sum }_{k = 1}^{n} {( {y}_{1 k} - {y}_{2 k} )}^{2}}{{\sum }_{k = 1}^{n} {( {x}_{1 k} - {x}_{2 k} )}^{2}}} \qquad ( 11 )$$

In the present embodiment, the distance between clusters is judged using the distance index (I, d, cos θ). For example, if the distance index between the cluster C1 and the cluster C2 is (I₁, d₁, cos θ₁), then closeness between clusters is calculated by using

$$\sqrt{{{A}_{1} ( {l}_{1} - 1 )}^{2} + {A}_{2} {d}_{1}^{2} + {{A}_{3} ( cos {θ}_{1} - 1 )}^{2}} \qquad ( 12 )$$

by giving weights to the all elements in the distance index (I₁, d₁, cos θ₁). Here, A₁, A₂ and A₃ are suitable positive constants.

Or the distance between clusters may be defined as

$$\sqrt{{A}_{2} {d}_{1}^{2} + {{A}_{3} ( cos {θ}_{1} - 1 )}^{2}} \qquad ( 13 )$$

using the distance d and angle θ in order to collect parallel segments in the neighborhood.

A pair of clusters in which the value obtained by using the equation (12) or the equation (13) is minimized is selected, and the selected clusters are unified.

Here, the clusters may be unified as hereafter described.

First, re-clustering is conducted by using segments obtained from each cluster. In other words, data belonging to a segment region which is a definite distance r or less from the segment is regarded as a cluster (segment cluster). An example of a segment region formed by a segment AB is shown in FIG. 12. Segment clusters are found with respect to respective segments. For respective segments, r is, for example, the same. If data which does not belong to any segment region exists, then r of each segment is gradually lengthened and the data is regarded as belonging to a region the data first enters. In the present example, clusters to be unified are segment clusters. Segment clusters to be unified are selected by using the equation (11) or the equation (12) in the same way as the foregoing description, and the selected segment clusters are unified. According to the present example, more suitable clustering can be anticipated although the amount of calculation increases, as compared with the example described above.

### Fourth Embodiment

If subject data is two-dimensional data, then an n-th order polynomial equation
y=a₀+a₁x+a₂x²+ . . . +aₙxⁿ (14)
may be used as a model instead of a straight line.

For example, if a model is formed using a quadratic polynomial, the distance between clusters can be calculated using three parameters (a₀, a₁, a₂) in y=a₀+a₁x+a₂x². Supposing that there are N sets of data (x₁, y₁), (x₂, y₂), . . . , (x_{N}, y_{N}) in a cluster, respective parameters can be found as follows:

$$[ \begin{matrix}{a}_{0} \\ {a}_{1} \\ {a}_{2}\end{matrix} ] = {[ \begin{matrix}N & {\sum }_{i = 1}^{N} {x}_{i} & {\sum }_{i = 1}^{N} {x}_{i}^{2} \\ {\sum }_{i = 1}^{N} {x}_{i} & {\sum }_{i = 1}^{N} {x}_{i}^{2} & {\sum }_{i = 1}^{N} {x}_{i}^{3} \\ {\sum }_{i = 1}^{N} {x}_{i}^{2} & {\sum }_{i = 1}^{N} {x}_{i}^{3} & {\sum }_{i = 1}^{N} {x}_{i}^{4}\end{matrix} ]}^{- 1} \cdot [ \begin{matrix}{\sum }_{i = 1}^{N} {y}_{i} \\ {\sum }_{i = 1}^{N} {x}_{i} {y}_{i} \\ {\sum }_{i = 1}^{N} {x}_{i}^{2} {y}_{i}\end{matrix} ] \qquad ( 15 )$$

Denoting parameters of the cluster 1 by (a₀¹, a₁¹, a₂¹) and parameters of the cluster 2 by (a₀², a₁², a₂²), the distance D between the clusters can be calculated, for example, as follows:

$$D = \sqrt{{( {a}_{0}^{1} - {a}_{0}^{2} )}^{2} + {( {a}_{1}^{1} - {a}_{1}^{2} )}^{2} + {( {a}_{2}^{1} - {a}_{2}^{2} )}^{2}} \qquad ( 16 )$$

What is claimed is:

1. A clustering apparatus comprising:
an initial cluster generator configured to divide multi-dimensional data to generate a plurality of clusters each including one or more data pieces;
a cluster recorder configured to record the clusters generated;
a cluster selector configured to calculate parameters of a previously given model which is common to the clusters, from each of the clusters, and select clusters to be unified on the basis of the parameters calculated from each cluster;
a cluster unifier configured to unify clusters selected by the cluster selector to generate a new cluster; and
a cluster evaluator configured to calculate an evaluation value for evaluating a set of the clusters except the unified clusters and the new cluster.

2. The clustering apparatus according to claim 1,
wherein the initial cluster generator
generates an initial cluster model from each of the clusters generated by the initial cluster generator,
calculates errors of the generated initial cluster models respectively, by using the data belonging to each cluster, and
divides the cluster having the initial cluster model whose error does not satisfy a specified value.

3. The clustering apparatus according to claim 1, wherein the cluster selector calculates a distance between two clusters based on the parameters of the two clusters, on each of plurality of pairs of two clusters, and selects the pair of two clusters having a minimum distance as the clusters to be unified.

4. The clustering apparatus according to claim 1, wherein the cluster selector calculates a distance between two clusters based on the parameters of the two clusters, on each of plurality of pairs of two clusters, and selects pairs of two clusters having a distance equal to or less than a predetermined value respectively, as the clusters to be unified.

5. The clustering apparatus according to claim 1, wherein the cluster evaluator calculates the evaluation value by using a number of clusters included in the set.

6. The clustering apparatus according to claim 5, wherein the cluster evaluator calculates an error on each of the models having the parameters calculated from each cluster included in the set, and calculates the evaluation value by using the errors calculated from said each cluster.

7. The clustering apparatus according to claim 1, wherein the cluster selector uses a linear regression equation as the previously given model.

8. The clustering apparatus according to claim 1, wherein the cluster selector uses a segment as the previously given model.

9. The clustering apparatus according to claim 1, wherein the cluster selector uses a polynomial equation as the previously given model.

10. A clustering method comprising:
dividing multi-dimensional data to generate a plurality of clusters each including one or more data pieces;
recording the clusters generated;
calculating parameters of a previously given model which is common to the clusters, from each of the clusters;
selecting clusters to be unified on the basis of the parameters calculated from each cluster;
unifying clusters selected to generate a new cluster;
calculating an evaluation value for evaluating a set of the clusters except the unified clusters and the new cluster; and
returning to the selecting in a case where the evaluation value does not satisfy a threshold value.

11. The clustering method according to claim 10, further comprising:
generating an initial cluster model from each of the clusters generated by the dividing,
calculating errors of the generated initial cluster models respectively, by using the data belonging to each cluster, and
dividing the cluster having the initial cluster model whose error does not satisfy a specified value.

12. The clustering method according to claim 10, wherein the selecting includes calculating a distance between two clusters based on the parameters of the two clusters, on each of plurality of pairs of two clusters, and selecting the pair of two clusters having a minimum distance as the clusters to be unified.

13. The clustering method according to claim 10, wherein the selecting includes calculating a distance between two clusters on the basis of parameters of the two clusters, on each of plurality of pairs of two clusters, and selecting pairs of two clusters having a distance equal to or less than a predetermined value respectively, as the clusters to be unified.

14. The clustering method according to claim 10, wherein the calculating the evaluation value includes calculating the evaluation value by using a number of clusters included in the set.

15. The clustering method according to claim 14, wherein the calculating the evaluation value includes calculating an error on each of the models having the parameters calculated from each cluster included in the set, and calculating the evaluation value by using the errors calculated from said each cluster.

16. The clustering method according to claim 10, wherein the calculating the parameters includes using a linear regression equation as the previously given model.

17. The clustering method according to claim 10, wherein the calculating the parameters includes using a segment as the previously given model.

18. The clustering method according to claim 10, wherein the calculating the parameters includes using a polynomial equation as the previously given model.

19. A computer program, comprising instructions for:
dividing multi-dimensional data to generate a plurality of clusters each including one or more data pieces;
recording the clusters generated;
calculating parameters of a previously given model which is common to the clusters, from each of the clusters;
selecting clusters to be unified on the basis of the parameters calculated from each cluster;
unifying clusters selected to generate a new cluster;
calculating an evaluation value for evaluating a set of the clusters except the unified clusters and the new cluster; and
returning to the selecting in a case where the evaluation value does not satisfy a threshold value.

20. The computer program according to claim 19, further comprising instructions for:
generating an initial cluster model from each of the clusters generated by the dividing,
calculating errors of the generated initial cluster models respectively, by using the data belonging to each cluster, and
dividing the cluster having the initial cluster model whose error does not satisfy a specified value.
